(19) United States
(12) Patent Application Publication
(10) Pub. No.: US 2008/0042500 A1
(43) Pub. Date: Feb. 21, 2008

(54) Shock-absorbent structure of motor

(75) Inventors: Alex Horng, Kaohsiung City (TW); Shih Chang Huang, Kaohsiung City (TW)

Correspondence Address: BACON & THOMAS, PLLC, 625 SLATERS LANE, FOURTH FLOOR, ALEXANDRIA, VA, 22314, US

(73) Assignee: Sunonwealth Electric Machine Industry Co., Ltd., Kaohsiung City (TW)

(21) Appl. No.: 11/606,099

(22) Filed: Nov. 30, 2006

(30) Foreign Application Priority Data
Aug. 21, 2006 (TW) 95130625

(51) Int. Cl. H02K 5/24; H02K 5/16

(52) U.S. Cl. 310/51; 310/90

(57) ABSTRACT

The present invention relates to a shock-absorbent structure of motor, which includes an upper case and a lower case assembled for accommodation of a rotor to rotate therein. A shaft seat is formed on the upper case and the lower case respectively; a bearing is disposed in the shaft seat, and a shock-absorbent member serving to absorb and dampening shock is disposed between the shaft seat and the bearing. Therefore, when a spindle of the rotor is pivotally disposed in two bearings and rotated therein, the shock-absorbent member can absorb, isolate and dampen the vibration amplitude generated by rotation of the rotor and by attrition between the spindle and the bearing, thereby preventing the vibration amplitude from impacting the system and thus maintaining the normal efficacy and the operational life duration thereof.

### FIELD OF THE INVENTION

The present invention relates to a shock-absorbent structure of motor, and more particularly to a practical structure that can isolate and dampen the vibration amplitude resulting from rotation of motor rotor to thereby protect system and maintain normal efficacy and operational life duration thereof.

### BACKGROUND OF THE INVENTION

As shown in FIG. 1, a motor including axial windings and radial air gaps is illustrated and contains an upper case and a lower case 12, in which both cases are composed of a magnetic material, a shaft seat 13 is formed in the upper case 11 and the lower case 12 respectively, and a bearing is disposed in the shaft seat 13.

A coil holder 15 equipped with axial windings is disposed inside the upper and the lower cases 11 & 12 and is made of an insulating material. The axial windings are constituted by a metal wire, and the metal wire has a terminal for power input. The coil holder 15 has a center hole for magnetic poles 161 & 171 of a top silicon steel plate 16 and a bottom silicon steel plate 17 respectively to be inserted along two sides of the center hole, and the magnetic poles 161 & 171 are formed in a mutually interlaced manner. A circuit board 18 and an insulation layer 19 are also disposed in the top and the bottom cases 11 & 12, and the insulation layer 19 isolates the circuit board 18 from the upper case 11 or the lower case 12.

A spindle 21 is bundled with a motor rotor 20 and is pivotally disposed in bearings 14 of the two shaft seats 13 so as to rotate therein. The rotor 20 is located inside the center hole of the coil holder 15 and corresponds to positions of the magnetic poles 161 & 171 of the top and the bottom silicon steel plates 16 & 17.

As the vibration amplitude arising from rotation of the aforementioned motor rotor will be transmitted outwards to result in serious resonance across the entire motor and even across peripheral electronic systems when the motor is operating, several disadvantages of such motor are concluded as follow:

1. Severe resonant condition: When the motor operates, vibration arising from rotation of the rotor 20 and attrition between the spindle 21 and the bearings 14 will be directly transmitted to the entire motor through the shaft base 13 to further impact on the normal efficacy of the peripheral electronic systems of the motor and to give rise to severe resonance thereof.

2. Shorter life cycle of motor and system resulting from resonance: When a system is consistently operated under a vibrating environment, the resonant effect not only impacts on the efficacy of the entire electronic system, but also speeds up premature fatigue and aging of contact points of electronic components inside the motor and shortens the life duration of the system.

3. Acute noise: The resonant effect is simultaneously accompanied with enormous noise, which dominates the overall noise value assessment significantly.

As a result, to completely solve the resonant effect of the aforementioned motor and electronic systems and maintain the normal efficacy and the operational life duration thereof, a more concrete damping and shock-absorbent measure shall be adopted, and thus a shock-absorbent structure of the motor urgently to be developed is on top of the list.

### SUMMARY OF THE INVENTION

In view of the foregoing concern, the present invention thus provides a shock-absorbent structure of motor including an upper case, a lower case, a coil holder with axial windings, a main body, a peripheral loop coil, a spindle, a rotor and a shock-absorbent member, wherein the upper case and the lower case are mutually matched and assembled and are also possibly disposed on a top and a bottom portions of the main body respectively, the coil holder with axial windings is contained in the cases, the main body and peripheral loop coil are composed of a plurality of silicon steel plates and are used to drive a rotor to rotate, a shaft seat is provided on the upper case and the lower case respectively, a bearing is disposed in the shaft seat, and the rotor is bundled with the spindle pivotally disposed in the bearing of the two shaft seats and rotated therein and corresponds to positions of magnetic poles of the coil holder or to a position of the loop coil of the main body.

As the shock-absorbent member is disposed between the aforementioned shaft seat and bearing respectively and is made of a flexible material capable of absorbing and dampening vibration, the vibration amplitude generated by rotation- of the rotor and attrition between the spindle and the bearing is absorbed, isolated and dampened by the shock-absorbent member without being transmitted outward, so as to protect the overall motor and the peripheral electronic systems against the resonant effect and maintain the normal efficacy and the operational life duration thereof.

### BRIEF DESCRIPTION OF THE DRAWINGS

FIG. 1 is a cross-sectional view showing a conventional shock-absorbent structure of motor;

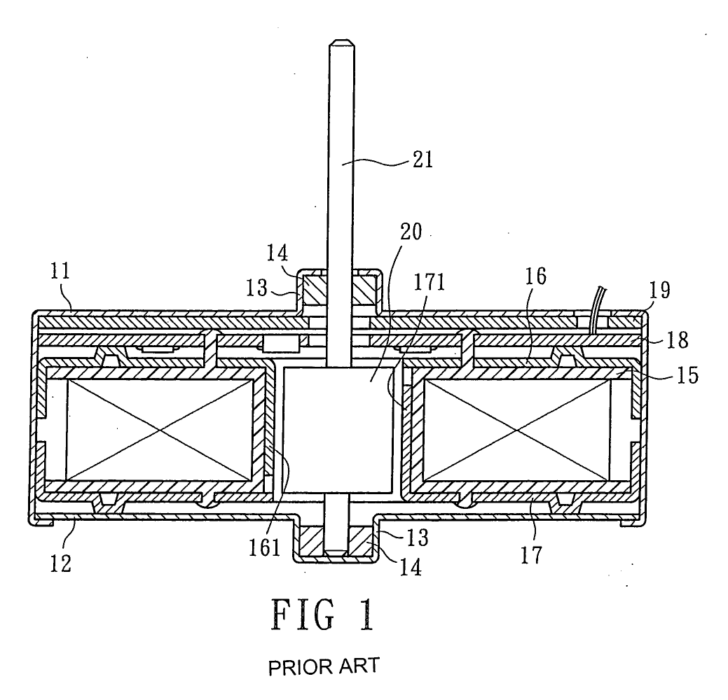

FIG. 2 is a cross-sectional view showing a first preferred embodiment of the present invention;

FIG. 3 is an exploded view showing a second preferred embodiment of the present invention; and

FIG. 4 is a cross-sectional view showing a second preferred embodiment of the present invention.

### DETAILED DESCRIPTION OF THE PREFERRED EMBODIMENT

The present invention relates to a shock-absorbent structure of motor, which has a shock-absorbent member disposed between a shaft seat and a bearing in an upper case and an lower case of a motor respectively, such that the vibration amplitude generated by rotation of a rotor and by attrition between a spindle and a bearing won't be transmitted outwards to thereby isolate the impact of vibration from the system.

Here are several preferred embodiments actually employed in the motor in the present invention for illustration:

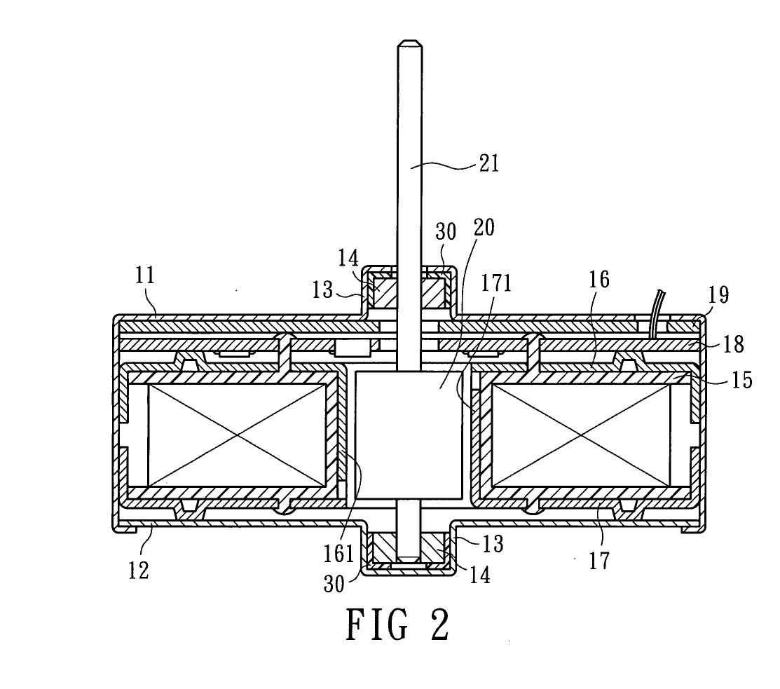

As shown in FIG. 2 illustrative of a first embodiment, an upper case 11 and a lower case 12 are provided and are made of a magnetic permeable material, and a shaft seat 13 is disposed on the upper case 11 and the lower case 12 respectively, and a bearing 14 is disposed in each of the two shaft seats.

A coil holder 15 having axial windings is enclosed by the upper and the lower cases 11 & 12 and is made of an insulating material, in which the axial windings are formed by a metal wire, the coil holder 15 has a center hole for magnetic poles 161 & 171 of an upper silicon steel plate 16 and a lower silicon steel plate 17 to be inserted along two sides thereof, and the magnetic poles 161 & 171 are formed in a mutually interlaced manner.

Moreover, a circuit board 18 and an insulating layer 19 are disposed in the upper and the lower cases 11 & 12, and the insulating layer 19 can isolate the circuit board 18 from the upper case 11 or the lower case 12.

The motor includes a rotor 20 and the rotor is bundled with a spindle 21, in which the spindle 21 is pivotally disposed in the bearings 14 of two shaft seats 13 so as to rotate therein, and the rotor 20 is located inside the center hole of the coil holder 15 and corresponds to positions of the magnetic poles 161 & 171 of the upper and lower silicon steel plates 16 & 17.

The present invention is characterized by providing a shock-absorbent member 30 disposed between the respective shaft seat 13 and bearing 14 of the upper and lower cases 11 & 12. The shock-absorbent member 30 shall be made of a flexible material, e.g. rubber, foam, sponge, polyurethane and the like, capable of absorbing and dampening shock. Consequently, when the motor operates, the vibration amplitude generated by rotation of the motor and by attrition between the spindle 21 and the bearing 14 can be absorbed, isolated and dampened through a shock-absorbent member 30 without being transmitted outwards, so as to protect the overall motor and its peripheral electronic systems against the resonant effect and maintain the normal efficacy and the operational life duration thereof.

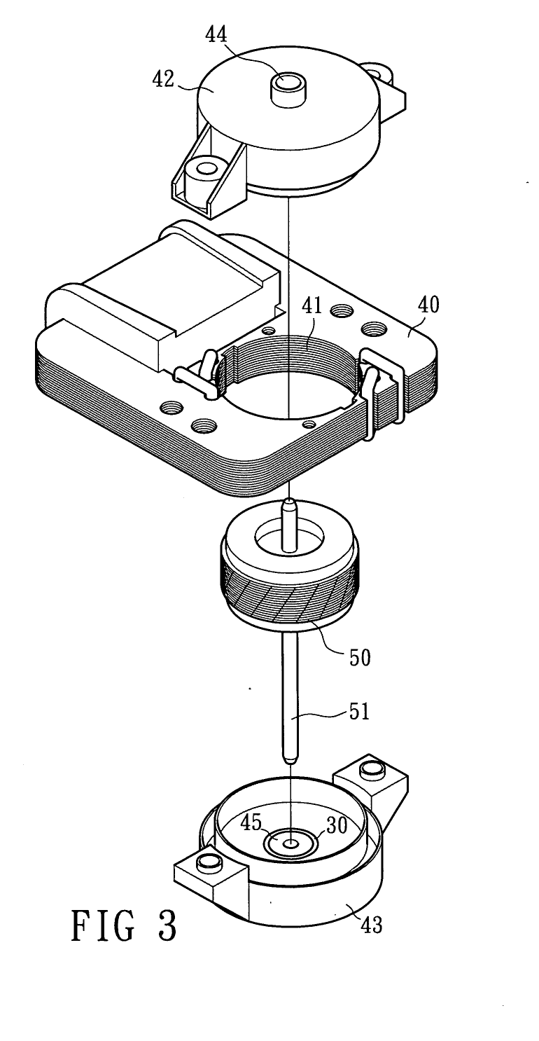

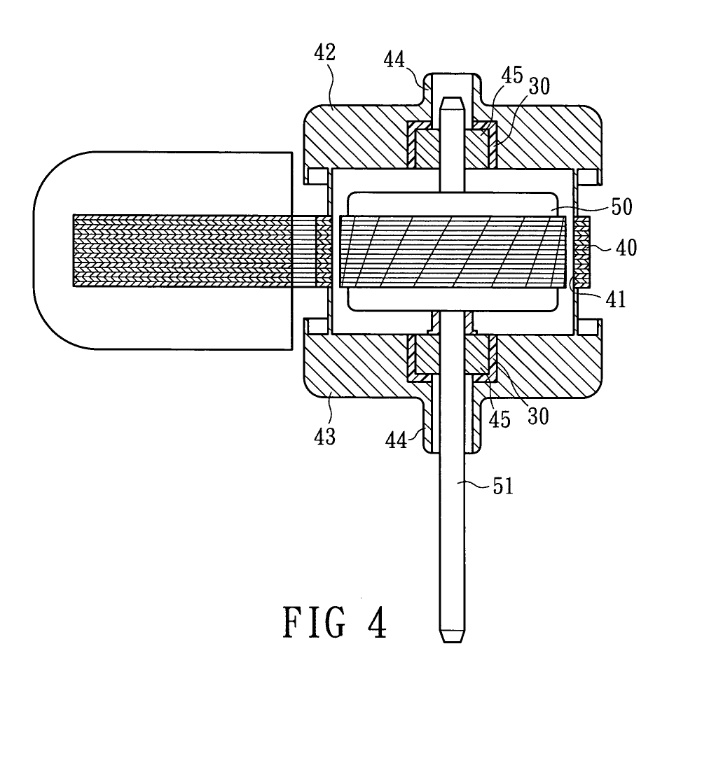

As shown in FIG. 3 and FIG. 4 illustrative of a second preferred embodiment, the motor of this type includes a main body 40, which is formed by stacking a plurality of silicon steel plates and has a center hole 41 and a loop coil disposed on a periphery of the center hole 41.

An upper case 42 and a lower case 43 are fixed above and under the center hole 41 of the main body 40, a shaft seat 44 is formed in the upper case and the lower case respectively and a bearing 45 is disposed in each of the two shaft seats 44.

A rotor 50 is bundled with a spindle, in which the spindle 51 is pivotally disposed in the bearings 45 of two shaft seats 44 so as to rotate therein, and the rotor is located inside the center hole 41 of the main body 40 and corresponds to the position of the loop coil.

A shock-absorbent member 30 is disposed between the shaft seat 44 and the bearing 45 of the upper and lower cases 42 & 43 respectively and shall be made of a flexible material, e.g. rubber, foam, sponge, polyurethane and the like, capable of absorbing and dampening vibration. As such, when the rotor 50 rotates, the vibration amplitude generated by rotation of the rotor and by attrition between the spindle 51 and the bearing 45 can be absorbed, isolated, dampened and prevented from being transmitted outward by the shock-absorbent member 30 such that the overall motor and the peripheral electronic systems won't be affected by the resonant effect and the normal efficacy and the operational life duration can be maintained.

In sum, the shock-absorbent structure of the present invention can isolate and dampen the vibration amplitude generated by rotation of the rotor and by attrition between the spindle and the bearing to prevent the vibration amplitude from transmitting outwards, so as to avoid the overall motor and its peripheral electronic systems to generate resonant effect and maintain the normal efficacy and operational life duration. Such feature not only has a novelty among similar products and a progressiveness, but also has an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A shock-absorbent structure of motor, comprising:
an upper case and a lower case each having a shaft seat and a bearing disposed in said shaft seat;
a rotor bundled with a spindle pivotally disposed in said bearings of said two shaft seats and rotated in said bearings;
a shock-absorbent member disposed between said shaft seat and said bearing and made of a flexible material being shock-absorbing and shock-dampening;
wherein said shock-absorbent member is made from one of rubber, foam, sponge, and polyurethane.

2. (canceled)

3. The shock-absorbent structure of motor of claim 1, wherein a coil holder is disposed in said upper case and said lower case, is made of an insulating material, contains axial windings composed of a metal wire, and has a center hole for magnetic poles of an upper silicon steel plate and an lower silicon steel plate to be inserted along two sides thereof such that said magnetic poles of said upper silicon steel plate and said lower silicon steel plate are formed in an interlaced manner, and said rotor is placed inside said center hole to correspond to positions of said magnetic poles of said upper and lower silicon steel plates.

4. The shock-absorbent structure of motor of claim 3, wherein a circuit board and an insulating layer are disposed in said upper and lower case, and said insulating layer isolate said circuit board from said upper case or said lower case.

5. The shock-absorbent structure of motor of claim 1, wherein said upper case and said lower case are disposed on a top part and a bottom part of a main body respectively, said main body is formed by stacking a plurality of silicon steel plates and has a center hole surrounded by a loop coil around a periphery of said center hole, and said rotor is placed inside said center hole and corresponds to a position of said loop coil of said main body.
